(19) United States
(12) Patent Application Publication
(10) Pub. No.: US 2008/0035732 A1
(43) Pub. Date: Feb. 14, 2008

(54) Uniform illumination without specular reflection in imaging reader

(76) Inventors: Igor Vinogradov, Bay Shore, NY (US); Edward Barkan, Miller Place, NY (US); Mark Drzymala, Commack, NY (US); Darran Handshaw, Miller Place, NY (US)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 11/496,307

(22) Filed: Jul. 31, 2006

(51) Int. Cl. G06K 7/10

(52) U.S. Cl. 235/462.42; 235/462.41

(57) ABSTRACT

A target is uniformly illuminated with illumination light without specular reflections from a window and/or from the target in a field of view of a solid-state imager of an imaging reader to improve reader performance.

### DESCRIPTION OF THE RELATED ART

Flat bed laser readers, also known as horizontal slot scanners, have been used to electro-optically read one-dimensional bar code symbols, particularly of the Universal Product Code (UPC) type, at a point-of-transaction workstation in supermarkets, warehouse clubs, department stores, and other kinds of retailers for many years. As exemplified by U.S. Pat. No. 5,059,779; U.S. Pat. No. 5,124,539 and U.S. Pat. No. 5,200,599, a single, planar horizontal window is set flush with, and built into, a horizontal countertop of the workstation. Products to be purchased bear an identifying symbol and are typically slid or swiped across the horizontal window through which a multitude of scan lines in a scan pattern is projected in a generally upward direction. Each scan line is generated by sweeping a laser beam from a laser. When at least one of the scan lines sweeps over a symbol associated with a product, the symbol is processed and read.

Instead of, or in addition to, a horizontal slot scanner, it is known to provide a vertical slot scanner, which is typically a portable reader placed on the countertop such that its planar window is generally vertical and faces an operator at the workstation. The generally vertical window is oriented perpendicularly to the horizontal window, or is slightly rearwardly inclined. A scan pattern generator within the vertical slot scanner also sweeps a laser beam and projects a multitude of scan lines in a scan pattern in a generally outward direction through the vertical window toward the operator. The operator slides or swipes the products past either window from right to left, or from left to right, in a “swipe” mode. Alternatively, the operator merely presents the symbol on the product to the center of either window in a “presentation” mode. The choice depends on operator preference or on the layout of the workstation.

These point-of-transaction workstations have been long used for processing transactions involving products associated with one-dimensional symbols each having a row of bars and spaces spaced apart along one direction, and for processing two-dimensional symbols, such as Code 39, as well. Code 39 introduced the concept of vertically stacking a plurality of rows of bar and space patterns in a single symbol. The structure of Code 39 is described in U.S. Pat. No. 4,794,239. Another two-dimensional code structure for increasing the amount of data that can be represented or stored on a given amount of surface area is known as PDF417 and is described in U.S. Pat. No. 5,304,786.

Both one- and two-dimensional symbols can also be read by employing solid-state imagers, instead of moving a laser beam across the symbols in a scan pattern. For example, an image sensor device may be employed which has a one- or two-dimensional array of cells or photosensors which correspond to image elements or pixels in a field of view of the device. Such an image sensor device may include a one- or two-dimensional charge coupled device (CCD) or a complementary metal oxide semiconductor (CMOS) device and associated circuits for producing electronic signals corresponding to a one- or two-dimensional array of pixel information over a field of view.

It is therefore known to use a solid-state device for capturing a monochrome image of a symbol as, for example, disclosed in U.S. Pat. No. 5,703,349. It is also known to use a solid-state device with multiple buried channels for capturing a full color image of a target as, for example, disclosed in U.S. Pat. No. 4,613,895. It is common to provide a two-dimensional CCD with a 640×480 resolution commonly found in VGA monitors, although other resolution sizes are possible.

To acquire an image of a symbol under low ambient light or in a dark environment, an illuminator is employed to illuminate the symbol during image capture. The illuminator typically includes a plurality of light sources, such as light emitting diodes (LEDs), within the reader. The illumination light from each LED is directed along an optical path generally perpendicular to the planar window, and is incident on, and passes through, the planar window of the reader en route to the symbol to be illuminated. However, a portion of each illumination light incident on the window may be reflected therefrom as specular reflection back towards, and captured by, the imager. Specular reflection may also result from reflections off the symbol, especially if the symbol is on a wrinkled or glossy surface. Such specular reflection may compromise decoding and degrade reader performance.

### SUMMARY OF THE INVENTION

One feature of the present invention resides, briefly stated, in a reader for, and a method of, electro-optically reading indicia, especially one- or two-dimensional symbols. The reader could be embodied as a stationary or portable point-of-transaction workstation having a planar window, or as a handheld reader having a planar window. In the case of the workstation, the symbol is swiped past, or presented to, the window and, in the case of the handheld reader, the reader itself is moved and aimed at the symbol. In one preferred embodiment, the workstation is installed in a retail establishment, such as a supermarket. In another preferred embodiment, the reader could be installed in an appliance, for example, a coffeemaker that reads a symbol on a coffee pack to identify how to prepare the coffee in the pack.

A one- or two-dimensional, solid-state imager is mounted in the reader, and includes an array of image sensors operative for capturing light from a one- or two-dimensional symbol or target through the window over a field of view during the reading. Preferably, the array is a CCD or a CMOS array.

In accordance with this invention, an illuminator is mounted in the reader and illuminates the symbol during the reading with illumination light directed from an illumination light source to and through the window along an optical path inclined relative to the window at an angle other than a right angle, for example, 45 degrees, to prevent specular reflection from the window and/or from the symbol from being captured by the imager. The outgoing illumination light travels in one direction through the same window as the incoming captured light travels in an opposite direction to the imager. The illumination light source includes at least one LED, and preferably a pair of LEDs. Each LED does not direct its light perpendicular to the plane of the window, but instead, its light is directed at a relatively steep angle of inclination toward the window. Any specular reflections off the window and/or the symbol are not captured by the imager, thereby improving reader performance.

The illumination light is directed at the angle of inclination toward the window in various ways. For example, if through-hole LEDs are used, then the leads on each LED may be bent so that a central axis of the emitted light is positioned at the angle of inclination. Alternatively, a tilted fold mirror could be used to direct the illumination light. Preferably, a light-transmissive optical element is used for directing the illumination light. The optical element may include an entrance surface through which the illumination light enters the optical element, an exit surface, preferably cylindrically curved, through which the illumination light exits the optical element, and a total internal reflecting surface for reflecting the illumination light entering via the entrance surface through the exit surface toward the window. The cylindrically curved surface is operative for optically modifying and focusing the illumination light passing therethrough. Alternatively, the optical element may be a refractive triangular prism.

In the preferred embodiment, a planar printed circuit board (PCB) is used for supporting the imager and the LEDs, and each LED is surface mounted on the PCB. Surface-mounted LEDs do not require manual soldering and bending of their leads, which is laborious, time-consuming, expensive and optically inaccurate. Hence, it is preferred to use the surface-mounted LEDs with the optical element to properly direct the illumination light.

The imager includes an imaging lens for capturing and focusing the light from the indicia onto the image sensors. In general, the imaging lens has a non-uniform light intensity distribution characteristic higher in a central area of the field of view of the imager as compared to outer peripheral areas of the field of view. The light non-uniformity within the field of view could compromise reader performance and may reduce the dynamic range of the reader.

Hence, another feature of this invention resides in spacing the LEDs apart by a certain spacing. More specifically, the illumination light of each LED is generally higher along a central axis of a conical volume of the emitted illumination light. This feature proposes spacing the LEDs sufficiently apart to position the central axes of the LEDs on the outer peripheral areas of the field of view, thereby rendering the light capture more uniform over the entire field of view.

In addition to the imaging lens, the imager also preferably includes an aperture stop to assist the imaging lens in focusing the light from the indicia onto the image sensors. The imaging lens may advantageously be a plano-convex lens, with its planar surface adjacent and preferably in contact with the aperture stop, and with its curved surface facing the imager.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a perspective view of a point-of-transaction workstation operative for capturing light from symbol-bearing targets;

FIG. 2 is a perspective view of an electro-optical reader operative in either a hand-held mode, or a workstation mode, for capturing light from symbol-bearing targets;

FIG. 3 is a schematic diagram of various components of the workstation of FIG. 1;

FIG. 4 is a broken-away, exploded, perspective view of various components in the workstation of FIG. 1 arranged in accordance with one embodiment of the invention;

FIG. 5 is a schematic side view of the components of the embodiment of FIG. 4;

FIG. 6 is a view analogous to FIG. 5 but of another embodiment of the invention; and

FIG. 7 is a schematic end view of some of the components in FIG. 5.

### DETAILED DESCRIPTION OF THE PREFERRED EMBODIMENTS

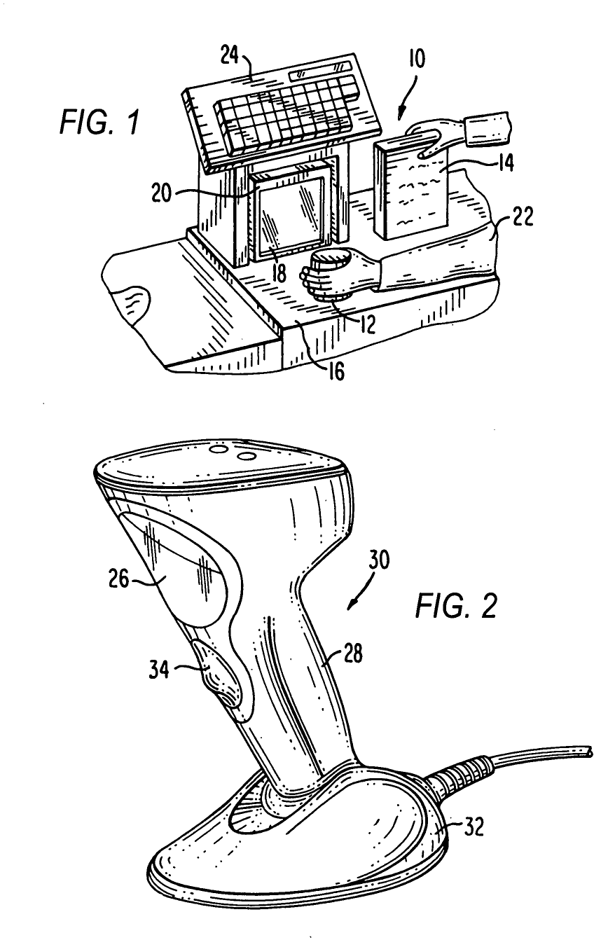

Reference numeral 10 in FIG. 1 generally identifies a workstation for processing transactions and specifically a checkout counter at a retail site at which products, such as a can 12 or a box 14, each bearing a target symbol, are processed for purchase. The counter includes a countertop 16 across which the products are slid at a swipe speed past a vertical planar window 18 of a box-shaped vertical slot reader 20 mounted on the countertop 16. A checkout clerk or operator 22 is located at one side of the countertop, and the reader 20 is located at the opposite side. A cash/credit register 24 is located within easy reach of the operator.

Reference numeral 30 in FIG. 2 generally identifies another reader having a different configuration from that of reader 20. Reader 30 also has a generally vertical window 26 and a gun-shaped housing 28 supported by a base 32 for supporting the reader 30 on a countertop. The reader 30 can thus be used as a stationary workstation in which products are slid or swiped past the vertical window 26, or can be picked up off the countertop and held in the operator's hand and used as a handheld reader in which a trigger 34 is manually depressed to initiate reading of the symbol.

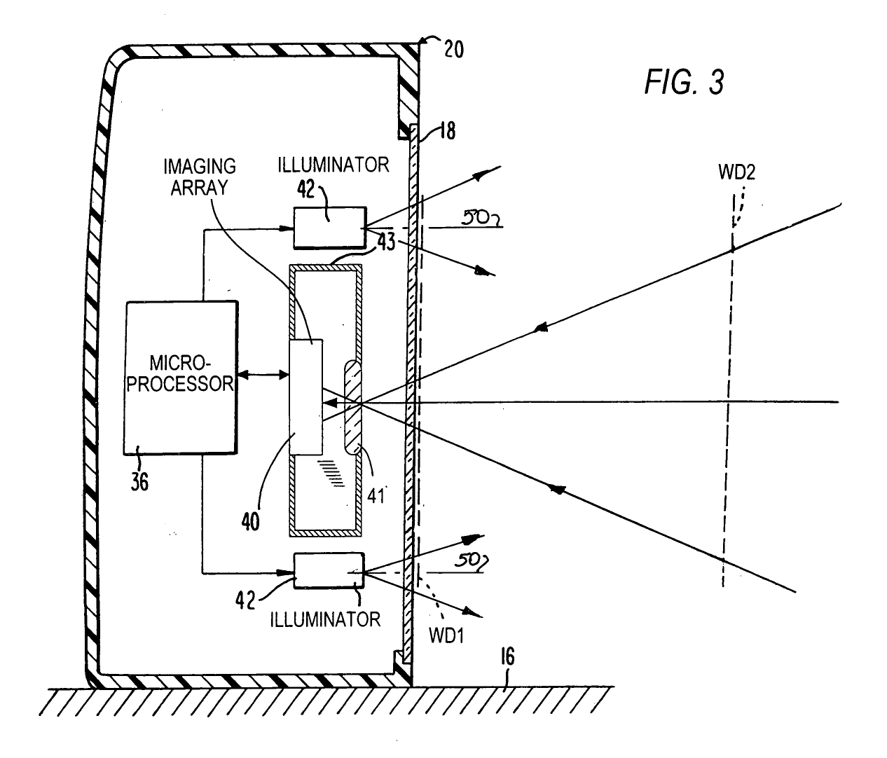

As described so far, the readers 20, 30 are conventional. As schematically shown in FIG. 3, an imager 40 and a focusing lens 41 are mounted in an enclosure 43 in either reader, such as the reader 20. The imager 40 is a solid-state device, for example, a CCD or a CMOS imager and has an array of addressable image sensors operative for capturing light through the window 18 from a target, for example, a one- or two-dimensional symbol, over a field of view and located in a working range of distances between a close-in working distance (WD1) and a far-out working distance (WD2). In a preferred embodiment, WD1 is about two inches from the imager array 40 and generally coincides with the window 18, and WD2 is about eight inches from the window 18. An illuminator is also mounted in the reader and preferably includes a plurality of light sources, e.g., light emitting diodes (LEDs) 42, arranged to uniformly illuminate the target, as described below.

As shown in FIG. 3, the imager 40 and the illuminator LEDs 42 are operatively connected to a controller or microprocessor 36 operative for controlling the operation of these components. Preferably, the microprocessor is the same as the one used for decoding light scattered from the indicia and for processing the captured target images.

In operation, the microprocessor 36 sends a command signal to pulse the illuminator LEDs 42 for a short time period, say 500 microseconds or less, and energizes the imager 40 to collect light from a target symbol only during said time period. A typical array needs about 33 milliseconds to read the entire target image and operates at a frame rate of about 30 frames per second. The array may have on the order of one million addressable image sensors.

As shown in FIG. 3, the illuminator LEDs 42 in accordance with the prior art directly face the window 18 at a distance therefrom. Each illuminator LED 42 is a pseudo-point source and emits an illumination beam over a generally conical spatial volume whose central axis 50 is generally perpendicular to the plane of the window 18. In operation, a portion of the illumination light from each LED incident on the window specularly reflects back from the window to the imager, and this specular reflection, if superimposed on the main target image of the symbol captured by the imager, may prevent the main target image from being decoded and successfully read. Specular reflection may also result from reflections off the target symbol, especially if the symbol is on a wrinkled or glossy surface.

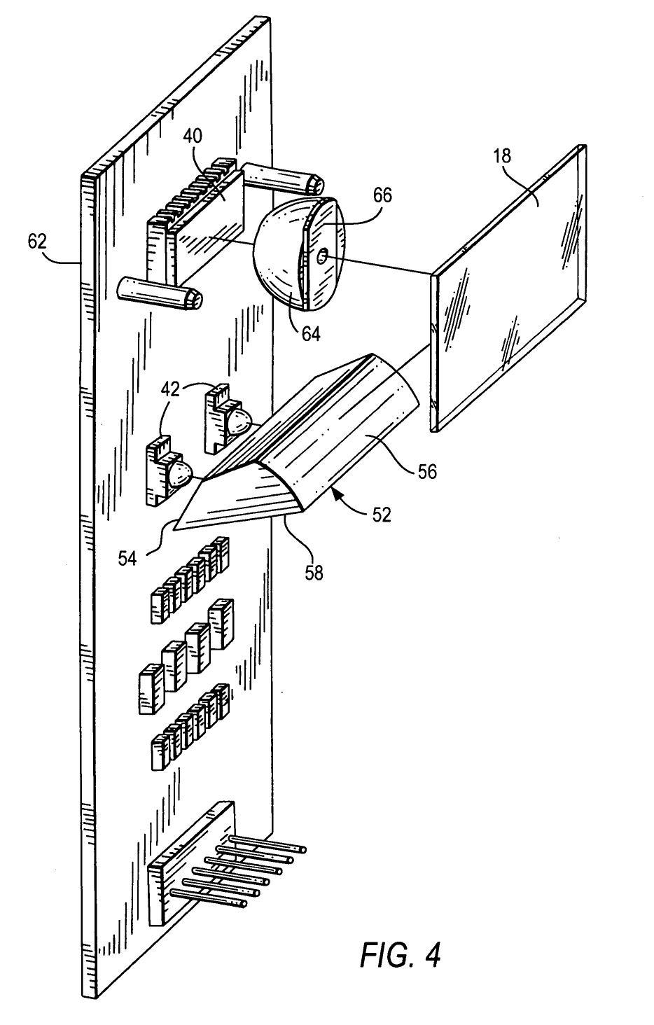

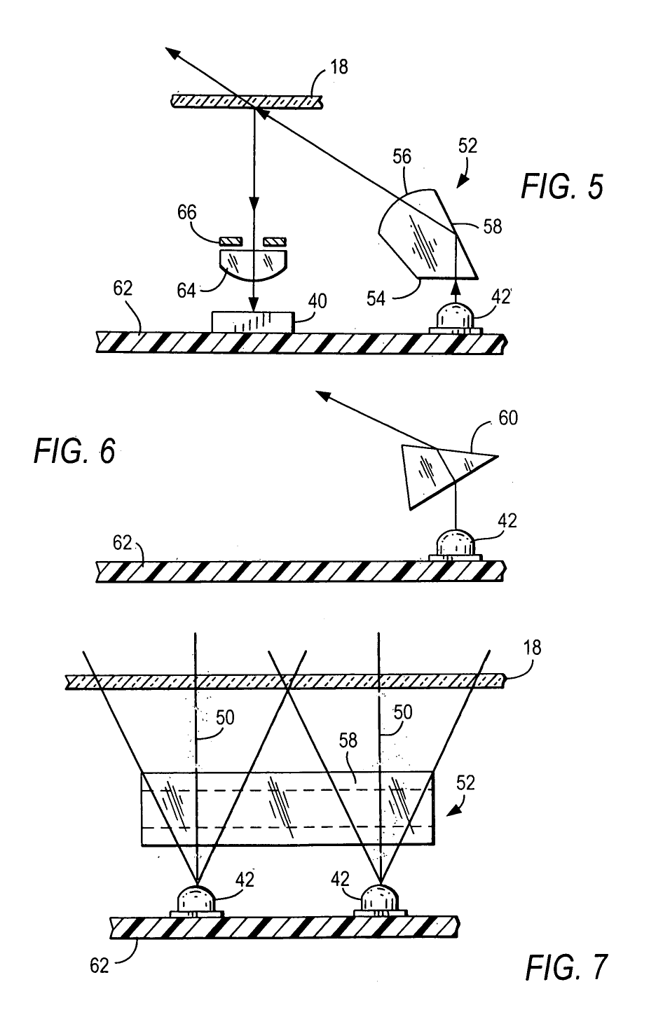

In accordance with this invention, as best seen in FIGS. 4-5, the illumination light emitted from the LEDs 42 is directed to and through the window 18 along an optical path inclined relative to the window 18 at an angle other than a right angle, for example, 45 degrees, to prevent specular reflection from the window 18 and/or from the target symbol from being captured by the imager 40. The outgoing illumination light travels in one direction through the same window 18 as the incoming captured light travels in an opposite direction to the imager 40. Each LED 42 does not direct its light perpendicular to the plane of the window 18, but instead, its light is directed at a relatively steep angle of inclination toward the window. Any specular reflections off the window 18 and/or the symbol are not captured by the imager 40, thereby improving reader performance.

The illumination light is directed at the angle of inclination toward the window 18 in various ways. For example, if through-hole LEDs are used, then the leads on each LED may be bent so that a central axis 50 of the emitted light is positioned at the angle of inclination. Alternatively, a tilted fold mirror could be used to direct the illumination light. Preferably, a light-transmissive optical element 52, as shown in FIGS. 4, 5, and 7, is used for directing the illumination light. The optical element 52 includes an entrance surface 54 through which the illumination light enters the optical element, an exit surface 56, preferably cylindrically curved, through which the illumination light exits the optical element, and a total internal reflecting surface 58 for reflecting the illumination light entering via the entrance surface through the exit surface toward the window 18. The cylindrically curved surface 56 is operative for optically modifying and focusing the illumination light passing therethrough. Alternatively, as shown in FIG. 6, the optical element may be a refractive triangular prism 60 for refracting and directing the illumination light at the inclination angle toward the window 18.

In the preferred embodiment, a planar printed circuit board (PCB) 62 is used for supporting the imager 40 and the LEDs 42, and each LED 42 is surface mounted on the PCB 62. As previously discussed, surface-mounted LEDs do not require manual soldering and bending of their leads and, hence, the surface-mounted LEDs are particularly well suited for use with the optical element 52 or 60 to properly direct the illumination light.

The imager 40 includes an imaging lens 64 for capturing and focusing the light from the symbol onto the image sensors. In general, the imaging lens 64 has a non-uniform light intensity distribution characteristic higher in a central area of the field of view of the imager 40 as compared to outer peripheral areas of the field of view. The light non-uniformity within the field of view could compromise reader performance and may reduce the dynamic range of the reader.

Hence, as shown in FIG. 7, the LEDs 42 are spaced apart by a certain spacing. More specifically, the illumination light of each LED 42 is generally higher along the central axis 50 of the conical volume of the emitted illumination light. The LEDs are spaced sufficiently apart to position the central axes 50 of the LEDs 42 on the outer peripheral areas of the field of view, thereby rendering the light capture more uniform over the entire field of view.

In addition to the imaging lens 64, the imager also preferably includes an aperture stop 66 to assist the imaging lens 64 in focusing the light from the symbol onto the image sensors. The imaging lens 64 may advantageously be a plano-convex lens, with its planar surface adjacent and preferably in contact with the aperture stop, and with its curved surface facing the imager.

It will be understood that each of the elements described above, or two or more together, also may find a useful application in other types of constructions differing from the types described above. Thus, readers having different configurations can be used.

While the invention has been illustrated and described as an illuminator for uniformly illuminating a symbol without specular reflections in a field of view of an imager in an imaging reader, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims:

1. A reader for electro-optically reading indicia, comprising:
a) a housing having a window;
b) a solid-state imager in the housing and including an array of image sensors for capturing light through the window from the indicia over a field of view during reading; and
c) an illuminator in the housing for illuminating the indicia during reading with illumination light directed from an illuminating light source to and through the window along an optical path inclined relative to the window at an angle other than a right angle to prevent specular reflections from being captured by the imager.

2. The reader of claim 1, wherein the illuminating light source includes a plurality of light emitting diodes (LEDs), each LED projecting a conical volume of the illumination light having a central axis that intersects the window at an angle other than ninety degrees.

3. The reader of claim 2, wherein the illuminator includes an optical element for directing the illumination light from each LED to the window at an angle other than ninety degrees.

4. The reader of claim 3, wherein the optical element includes an entrance surface through which the illumination light enters the optical element, an exit surface through which the illumination light exits the optical element, and a total internal reflecting surface for reflecting the illumination light entering via the entrance surface through the exit surface.

5. The reader of claim 4, wherein the exit surface is cylindrically curved for optically modifying the illumination light passing therethrough.

6. The reader of claim 3, wherein the optical element is a refractive prism.

7. The reader of claim 2, and a planar printed circuit board (PCB) for supporting the imager and the LEDs, and wherein each LED is surface mounted on the PCB.

8. The reader of claim 2, wherein the imager includes an imaging lens for focusing the light from the indicia onto the image sensors with a light intensity characteristic higher in a central area of the field of view as compared to outer peripheral areas of the field of view, and wherein the illumination light of each LED is higher along the respective central axis, and wherein the LEDs are spaced apart to position the central axes on the outer peripheral areas, thereby rendering the light capture more uniform over the field of view.

9. The reader of claim 2, wherein the imager includes an aperture stop and an imaging lens for focusing the light from the indicia onto the image sensors.

10. A reader for electro-optically reading indicia, comprising:
a) housing means having a window;
b) solid-state imager means in the housing means and including an array of image sensors for capturing light through the window from the indicia over a field of view during reading; and
c) illuminator means in the housing means for illuminating the indicia during reading with illumination light directed from an illuminating light source to and through the window along an optical path inclined relative to the window at an angle other than a right angle to prevent specular reflections from being captured by the imager means.

11. A method of electro-optically reading indicia, comprising the steps of:
a) capturing light through a window of a reader from the indicia over a field of view during reading by an array of image sensors of a solid-state imager; and
b) illuminating the indicia during reading with illumination light directed from an illuminating light source to and through the window along an optical path inclined relative to the window at an angle other than a right angle to prevent specular reflections from being captured by the imager.

12. The method of claim 11, wherein the illuminating step is performed by projecting the illumination light from a plurality of light emitting diodes (LEDs) as conical volumes, each LED having a central axis that intersects the window at an angle other than ninety degrees.

13. The method of claim 12, wherein the illuminating step is performed by directing the illumination light from each LED to the window at an angle other than ninety degrees with an optical element.

14. The method of claim 13, and configuring the optical element with an entrance surface through which the illumination light enters the optical element, an exit surface through which the illumination light exits the optical element, and a total internal reflecting surface for reflecting the illumination light entering via the entrance surface through the exit surface.

15. The method of claim 14, and cylindrically curving the exit surface for optically modifying the illumination light passing therethrough.

16. The method of claim 13, and configuring the optical element as a refractive prism.

17. The method of claim 12, and surface mounting the imager and the LEDs on a planar printed circuit board (PCB).

18. The method of claim 12, wherein the imaging step is further performed by focusing the light from the indicia onto the image sensors with a light intensity characteristic higher in a central area of the field of view as compared to outer peripheral areas of the field of view, and wherein the illuminating step is performed with illumination light of each LED being higher along the respective central axis, and spacing the LEDs apart to position the central axes on the outer peripheral areas, thereby rendering the light capture more uniform over the field of view.

19. The method of claim 11, wherein the imaging step is further performed with an aperture stop and an imaging lens for focusing the light from the indicia onto the image sensors.

20. The method of claim 11, and constituting the window of a generally planar, light-transmissive material.
